(19) United States
(12) Patent Application Publication
(10) Pub. No.: US 2014/0331313 A1
(43) Pub. Date: Nov. 6, 2014

(54) AUTHENTICATION OF SIGNATURE USING ACOUSTIC WAVE ANALYSIS

(71) Applicant: VIALAB, INC., San Jose, CA (US)

(72) Inventors: Jee Hoon Kim, Cupertino, CA (US); Hyun Gi An, Suwon-si (KR)

(21) Appl. No.: 14/260,125

(22) Filed: Apr. 23, 2014

Related U.S. Application Data
(60) Provisional application No. 61/819,431, filed on May 3, 2013.

(51) Int. Cl. G06F 21/32; G06F 3/043

(52) U.S. Cl. CPC G06F 21/32; G06F 3/0433
USPC 726/16

(57) ABSTRACT

Embodiments relate to capturing an acoustic signal generated when generating a pattern of movement for authentication of a user (e.g., signing on a touchscreen for authentication of a signature). In addition to or in lieu of a digital image of the signature, the captured acoustic signal is used as information for authenticating the signature. To capture the acoustic signals, an electronic device includes a sensor for detecting the vibration on the touchscreen. During an initial registration process, the signal from the sensor is processed and stored for use as reference information. Subsequently received signals from the sensor are compared with the reference information to identify a signer or authenticate the signature.

### CROSS-REFERENCE TO RELATED APPLICATION

This application claims priority under 35 U.S.C. §119(e) to co-pending U.S. Provisional Patent Application No. 61/819,431 filed on May 3, 2013, which is incorporated by reference herein in its entirety.

### BACKGROUND

1. Field of Art

The disclosure relates to authenticating signatures made on a touchscreen by analyzing an acoustic signal generated while signing on the touchscreen.

2. Description of the Related Art

Signatures are generally used for authenticating a signer and formalizing various documents. With the advent of digital age, such signatures are often captured by an electronic signature capture terminal instead of writing on a sheet of paper. Digital images of the signatures may be stored in a storage device and later retrieved for authentication, if any issues later arise in the transaction. Each digital image takes up a relatively small amount of memory and can be easily processed using well known image processing algorithms.

For high stakes transactions, digital images of captured signatures are used less often. One of the reasons that prevent a wider use of the electronic signature capture terminal is its failure to capture certain features. Some features may not be captured or preserved due to low resolution of the digital images of the signatures, lack of information on writing speed, and lack of information on pressure exerted while writing. Due to the lack of such missing features in the captured digital images, the digital images captured by the electronic signature capture terminals may be sometimes difficult to authenticate.

Further, visual aspects of a signer's signature may be relatively easy to replicate by someone other than the signer. Especially, if the signature is captured and stored as a low resolution image data, a person may easily mimic most, if not all, the visual traits of the signature in the image data. Hence, the signature may be vulnerable to copying or mimicking by others claiming to be the person of signatory authority.

### SUMMARY

Embodiments relate to extracting features of acoustic signal generated by a signer at a first time when the signer writes a signature on an electronic device. The acoustic signal is detected at a sensor of the electronic device. The detected acoustic signal is processed to extract features that can be compared later to authenticate the signer or the signer's signature. The extracted features may be sent for storage in association with the signature or the signer of the signature.

In one embodiment, another acoustic signal is detected at a sensor of another electronic device at a second time to extract comparison features. The extract comparison features are extracted by processing the other acoustic signal. The comparison features and the stored reference information are compared to authenticate the signature or the signer.

### BRIEF DESCRIPTION OF DRAWINGS

FIG. 1 is a perspective view of an electronic device for capturing information of signatures, according to one embodiment.

FIG. 2 is a block diagram of electronic components in the electronic device of FIG. 1, according to one embodiment.

FIG. 3A is a cross sectional view of a touchscreen of the electronic device of FIG. 1 taken along line A-B, according to one embodiment.

FIG. 3B is a magnified view of a top surface of the touchscreen, according to one embodiment.

FIG. 4A is a flowchart illustrating an overall process of authenticating a signature, according to one embodiment.

FIG. 4B is a flowchart illustrating a process of extracting features of an acoustic signal, according to one embodiment.

FIG. 4C is a flowchart illustrating a process of comparing extracted features of acoustic signals, according to one embodiment.

FIG. 5A is a graph illustrating an example waveform of an acoustic signal generated when an original signer signs on the touch screen, according to one embodiment.

FIG. 5B is a graph illustrating a lowpass filtered waveform of the acoustic signal of FIG. 5A, according to one embodiment.

FIG. 6 is a diagram illustrating a signature image corresponding to the waveform of FIG. 5, according to one embodiment.

FIG. 7 is a graph illustrating another example waveform of an acoustic signal generated when the same signer of FIG. 5A signs on the touch screen, according to one embodiment.

FIG. 8 is a graph illustrating an example waveform of an acoustic signal generated when another signer produces a signature, according to one embodiment.

### DETAILED DESCRIPTION OF EMBODIMENTS

Embodiments are described herein with reference to the accompanying drawings. Principles disclosed herein may, however, be embodied in many different forms and should not be construed as being limited to the embodiments set forth herein. In the description, details of well-known features and techniques may be omitted to avoid unnecessarily obscuring the features of the embodiments.

In the drawings, like reference numerals in the drawings denote like elements. The shape, size and regions, and the like, of the drawing may be exaggerated for clarity.

Embodiments relate to capturing an acoustic signal generated when generating a pattern of movement for authentication of a user (e.g., signing on a touchscreen for authentication of a signature). In addition to or in lieu of a digital image of the signature, the captured acoustic signal is used as information for authenticating the signature. To capture the acoustic signals, an electronic device includes a sensor for detecting the vibration on the touchscreen. During an initial registration process, the signal from the sensor is processed and stored for use as reference information. Subsequently received signals from the sensor are compared with the reference information to identify a signer or authenticate the signature.

Features in the acoustic signal generated during the signing process are difficult to replicate by someone other than the original signer. Each person may have different styles of writing letters or words. For example, the pressure exerted on the pen or stylus at different parts of the signature and speed at which the pen or stylus touches and moves at different parts of the signature may differ for each person. Such differences in the pressure or speed while producing a signature results in detectable differences in an acoustic signal generated when producing the signature. Features in the acoustic signal are not easily replicated by mere visual inspection of the signature. Therefore, features in the acoustic signals may advantageously be used as information for authenticating or verifying a signer or a signature.

The features in the acoustic signal that can be used for authenticating or verifying a signature may include, among others, information indicative of speed and/or pressure of a writing medium (e.g., pen or stylus) at certain spatial locations of a signature image.

In one or more embodiments, key regions in the signature image and the information indicative of speed and/or pressure of the writing medium at corresponding portions of the acoustic signal are stored as features for comparison. The regions of interest may include, for example, regions at or near vertices, acceleration regions where the speed of a writing medium accelerates, and deceleration regions where the speed of the writing medium decelerates. In the acceleration regions, the frequency of the acoustic signal tends to increase. Conversely, the frequency of the acoustic signal tends to decrease in the deceleration region.

In other embodiments, the acoustic signal can be divided into multiple segments at certain points (e.g., where the amplitude of acoustic signal remains below a threshold), and then process the segments to extract certain features (e.g., the length of each segment, signal frequencies included in each segment and the energy in each segment) of the segments. The energy of a segment refers to the amplitude of the signal integrated over the time of the segment.

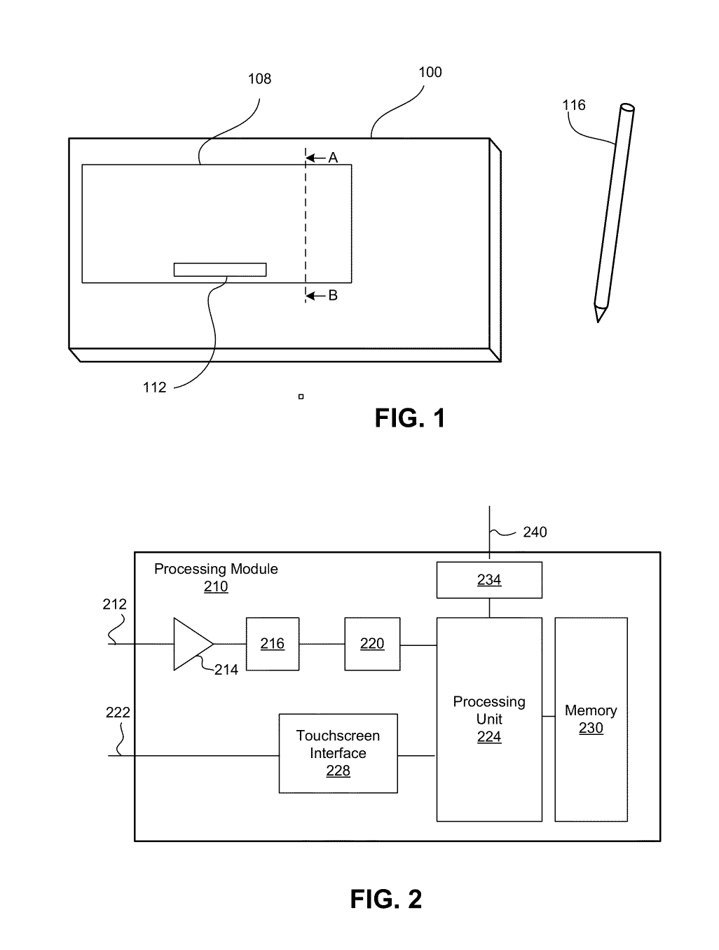

FIG. 1 is a perspective view of an electronic device 100 for capturing information of signatures, according to one embodiment. The electronic device 100 may be an electronic signature capture terminal, a smartphone, a tablet computer, a notebook computer or any other devices for processing data and authenticating signatures. The electronic device 100 may include, among other components, a touchscreen 108 and a sensor 112.

The touchscreen 108 may be embodied using various technologies to detect and track touch and motion on its surface. In one embodiment, a pen or stylus 116 is used by a signer to provide a signature on the touchscreen 108. Instead of using a pen or stylus 116, the signature may also be provided using various materials of various shapes such as a finger or other body parts (e.g., nail).

The sensor 112 detects vibrations in the touchscreen 108 as a result of the touch on the touchscreen 108 and generates a sensor signal corresponding to the vibrations. In one embodiment, the sensor 112 is embodied as a piezo sensor. Depending on the signature and the signer, the sensor signals detected at the sensor 112 have distinct waveforms. By extracting and comparing features of such waveforms, the signer and the signature can be identified and authenticated.

The sensor 112 may be placed in various parts of the touchscreen where the vibrations in the touchscreen 108 can be detected. In the embodiment of FIG. 1, the sensor 112 is placed on or below the touchscreen 108 oriented horizontally to more accurately capture vibrations in the touchscreen 108. However, the sensor 112 may be placed in different locations and orientations in the electronic device 100 to detect the vibrations in the touchscreen 108. Further, more than one sensor 112 may be provided in the electronic device 100 to enhance accuracy.

FIG. 2 is a block diagram of a processing module 210 in the electronic device 100 of FIG. 1, according to one embodiment. The processing module 210 receives acoustic signals via line 212 to store and/or detect features in acoustic signal generated when a signer produces a signature on the touchscreen 108. Specifically, the acoustic signal received via the line 212 is sent to an amplifier 214 to amplify the acoustic signal.

The amplified acoustic signal is then processed by noise filter 216 to remove noises. Then the acoustic signal is converted into a digital signal by an analog-to-digital converter (ADC) 220. The digital signal is sent to the processing unit 224 for storage as reference information or comparison with pre-stored reference information.

A processing unit 224 may be embodied as a microprocessor with one or more processing core. The processing unit 224 may be combined with memory 230 with other components (e.g., touchscreen interface 228) into a single integrated circuit (IC) chip. The processing unit 224 may perform operations such as lowpass filtering, detecting of amplitude of the acoustic signal dropping below a threshold and segmenting of the acoustic signal.

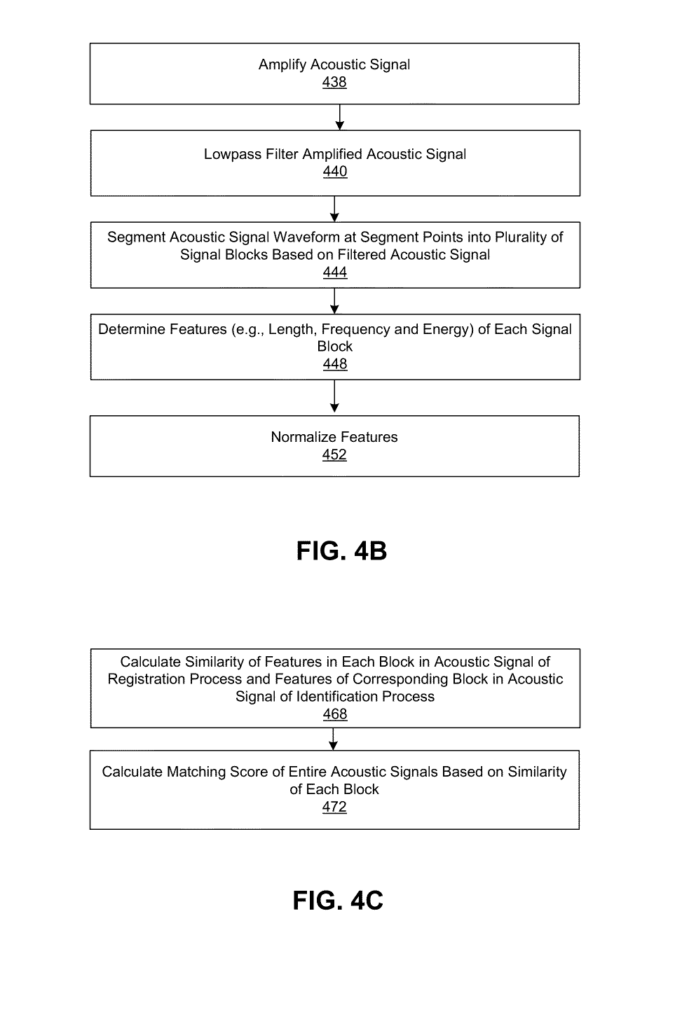

In a registration process, the features extracted from the signature image and acoustic features are stored in memory 230 in association with the identity of the signer as reference information, and in a subsequent identification process, the extracted features of in the image and acoustic signals are compared with the stored features to identify or authenticate the signer, as described below in detail with reference to FIG. 4.

Touchscreen information indicating the locations of the touchscreen 108 where the pen or stylus 116 touched and moved along the touchscreen 108 is received at a touchscreen interface 228 via line 222. The processing unit 224 processes the touchscreen information into a digital image representing the signature of the user and stored in the memory 230. The digital image of the signature may be associated with the reference information or the identification of the user and stored in the memory 230.

In one embodiment, the touchscreen information 222 may be used to detect spatial locations corresponding to certain key points of a signature (e.g., inflection point, top vertical location, bottom vertical location, rightmost location and leftmost location). Such key points of the signature may be correlated with or associated with certain temporal locations in the waveform of an acoustic signal. Features of the acoustic signal at these certain points may be used to comparing the signatures.

In other embodiments, the acoustic signal is segmented into multiple signal blocks and then characteristics or features of each signal block are extracted for comparison. The extracted characteristics or features may include, among others, the temporal length of each signal block, the frequency components of each signal block, and the energy of each signal block.

In one embodiment, the digital signal processed from the acoustic signal and/or the digital images of the signature are sent to an external device via device interface 234 and communication line 240 for further processing or storage.

The memory 230 is a non-transitory computer readable storage medium that stores instructions executable by the processing unit 224. The memory 230 may also store the touchscreen information and the reference information.

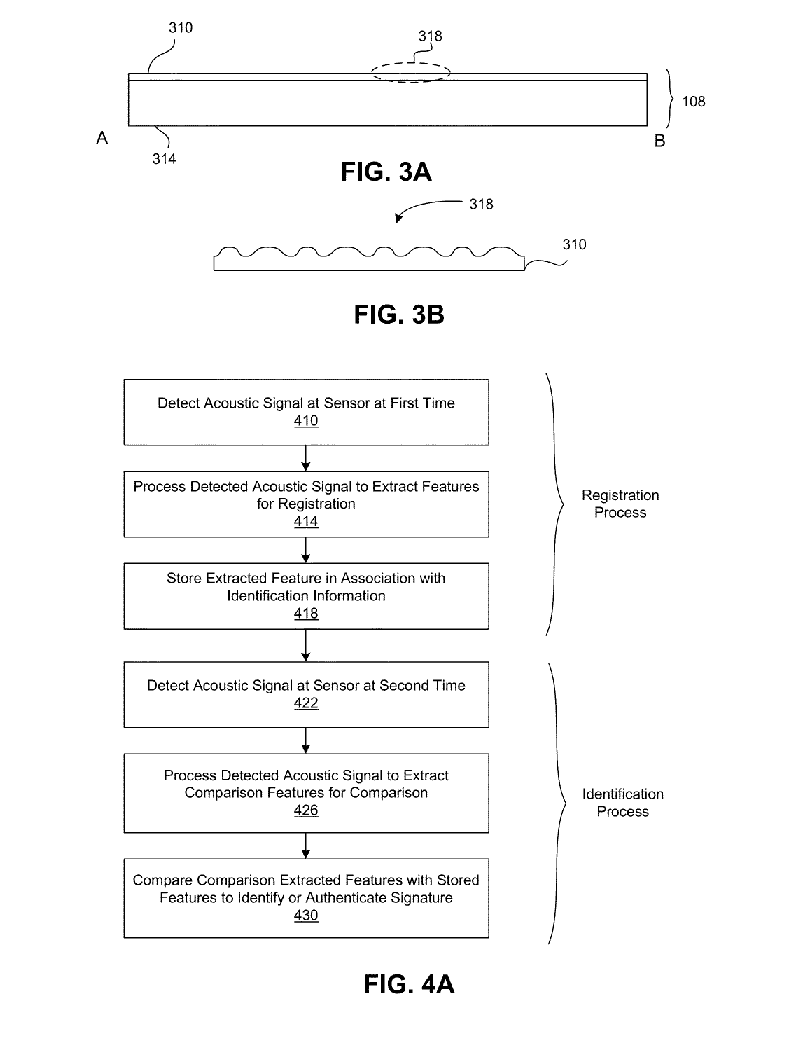

FIG. 3A is a cross sectional view of a touchscreen 108 of the electronic device 100 of FIG. 1 taken along line A-B, according to one embodiment. The touchscreen 108 may include a screen assembly 314 that includes electrodes (not shown) and a display device (e.g., liquid crystal display (LCD)) to display images as the signature is being written on the touchscreen 108. The screen assembly 314 is well known in the art, and therefore, the detailed description thereof is omitted herein. The touchscreen 108 also includes a top surface 310 placed on top of the screen assembly 314. The pen or stylus 116 comes into contact and moves along the top surface 310.

FIG. 3B is a magnified view of the top surface 310 of the touchscreen, according to one embodiment. The top surface 310 may be grated or patterned as illustrated in FIG. 3B to increase the vibrations detectable by the sensor 112 when the pen or stylus 116 moves on the top surface 310.

FIG. 4A is a flowchart illustrating a process of authenticating a signature, according to one embodiment. In a registration process, an acoustic signal generated during the movement of the pen or stylus 116 on the touchscreen is digitized and stored as reference information for the signature. In a subsequent identification process, a detected acoustic signal is digitized and compared with the stored reference information to identify or authenticate a signature provided in the identification process.

Specifically, the registration process starts with detecting 410 of an acoustic signal by the sensor 112 at a first time during which a signer moves the pen or stylus 116 on the touchscreen 108 to write his or her signature. Then the detected acoustic signal is processed 414 to extract features in the acoustic signal. The processing may include, for example, amplification of the acoustic signal, filtering of the acoustic signal to remove noise, lowpass filtering of the acoustic signal, dividing the digitized sensor signal into multiple segments, and performing frequency domain transform (e.g., fast Fourier transform or Wavelet transform) on the segmented acoustic signal blocks, as described in detail below with reference to FIG. 4B.

In one embodiment, the sensor signal or the digitized sensor signal is divided into multiple segments where each segment extends to cover a key region in the signature. Then, frequency domain transform may be performed on each of the segments. By computing dominant frequency components in the transformed segment, the speed of writing the signature in the corresponding key region can be extracted. Frequency domain features other than the writing speed (e.g., directional features from dispersive waveform) may also be extracted.

The extracted feature may be stored 418 in association with the signer's identification information. The identification information may represent any information for identifying the signer and may include, for example, the signer's name, a social security number or a unique user identification number. The extracted features may be stored in the electronic device 100 for detecting the acoustic signal. Alternatively, the extracted features may be stored at a location remote from the electronic device 100 for retrieval by the electronic device 100 or other devices. The registration is concluded by storing the extracted feature.

The identification process starts with detecting 422 of an acoustic signal at the sensor of an electronic device at a second time during which a signer writes his or her signature on a touchscreen of the electronic device. The electronic device used for the identification process need not be the same device on which the registration process was performed. That is, the registration process may be performed using one electronic device, and the identification process may be performed on another electronic device.

Further, the devices for performing the registration and the identification need not even be of the same type of device. For example, the registration process may be performed on a first type of smartphone and the identification process may be performed on a second type of smartphone. But it is advantageous that the electronic devices used for the registration process and the identification process have touchscreens of the same or similar acoustic characteristics so that the same signature written on both devices produce the same or similar acoustic features.

The acoustic signal detected at the second time is then processed 426 using the same or similar process performed during the registration process to extract comparison features, as described below in detail with reference to FIG. 4B. It is advantageous that the surface of the touch screen used at the second time have the same grating or patterns as the touch screen used at the first time so that a similar or the same movement at the first time and the second time produce a similar or the same acoustic signal.

The comparison features extracted from the acoustic signal detected at the second time are then compared 430 with the features stored during the registration process, as described below in detail with reference to FIG. 4C, to identify the signer or authenticate the signature. The comparing process may be performed on the electronic device that captured the signature in the identification process. Alternatively, the features extracted in the identification process may be sent to a remote computing device via a network to compare with the reference information.

The result of comparison can be used for various purposes. Example uses include verifying or authenticating a person providing the signature for credit card transactions or for unlocking an electronic device.

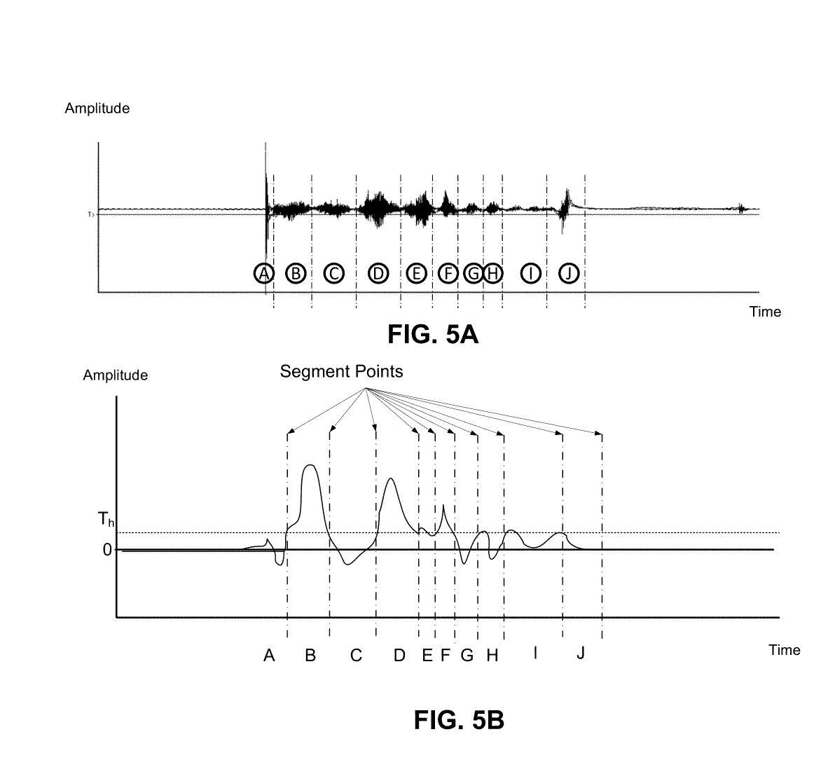

FIG. 4B is a flowchart illustrating a process of extracting features of an acoustic signal, according to one embodiment. The acoustic signal is amplified 438 for more subsequent signal processing processes. FIG. 5A is a graph illustrating an example waveform of an acoustic signal generated when an original signer signs on the touch screen, according to one embodiment. The vertical direction of the graph indicates amplitude and the horizontal direction indicates time. Parts of the waveform corresponding to parts of the signature where the pen or stylus is moving at a high speed tend to include more high frequency components. Conversely, parts of the waveform corresponding to parts of the signature where the pen or stylus is moving at a low speed tend to include more low frequency components.

The signature of FIG. 5A corresponds the word “kim,” and can be divided into 10 different segments “A” through “J”. Segment “A” represents the part of the waveform where the pen or stylus initially comes into contact with the touchscreen and the vibration of the touchscreen subsequently settles. Each of segments “B” through “I” represents a part of signature where the movement of the pen or stylus speeds up and then slows down. Segment “J” represents a part of signature where the pen or stylus is taken off from the touchscreen. In some embodiments, the first segment and the last segment (e.g., segment “A” and segment “J” in FIG. 5A) are discarded from further processing while the segments between these two segments are further processed to extract features.

Referring back to FIG. 4B, then the acoustic signal is lowpass filtered 440 to generate a filtered waveform. The filtering process generates a smooth waveform for determining segment points that can be used to segment the acoustic signal into multiple signal blocks. FIG. 5B is a diagram illustrating the waveform of FIG. 5A that is lowpass filtered. Based on the filtered acoustic signal, segment points for segmenting the amplified (but unfiltered) acoustic signal can be determined. The segment points can be determined, for example, at points where the filtered waveform drops below threshold amplitude. In the example of FIG. 5B, the threshold amplitude (Tₕ) is used to determine the segments points. Other points such as inflection points, local maxima or local minima of amplitude may be used as the segment points.

The amplified acoustic signal waveform is then segmented 444 into multiple segment blocks for further processing at segment points. In one embodiment, the segment points correspond to the points where the filtered waveform dropped below the threshold amplitude (Tₕ). Each signal block of the amplified signal is then processed to determine 448 features of the signal block. The features determined in this process may include, for example, the length of the signal block, the frequency components of the signal block and the energy of the signal block. To determine the frequency components of the signal block, the signal block may be frequency domain transformed (e.g., fast Fourier transform or Wavelet transform). The energy of the signal block may be determined by the equation of, ∫_{T1}^{T2}\sqrt{S²}dt where T1 refers to the time the signal block starts, T2 refers to the time the signal block ends, and S represents the signal.

Then the extracted features are normalized 452. The length of the signal block can be normalized, for example, using the duration of the longest signal block in a given acoustic signal as the denominator and dividing the length of each signal block by the denominator. Similarly, the energy of the signal blocks can the normalized by using the greatest energy of all the signal blocks in a given acoustic signal and then diving the energy of all the signal blocks by the greatest energy. The normalized versions of the signal block lengths and/or the energy can be used as features for comparison.

In one or more embodiments, the first segment (e.g., segment “A” of FIG. 5A) and the features of the last segment (e.g., segment “J” of FIG. 5B) are not processed to extract their features. The first segment and the last segment represent the signal generated when the pen or stylus comes into contact with the touch screen and when the pen or stylus is removed from the touch screen, respectively. These segments may vary significantly each time the user signs his or her signature on the touchscreen as may include a large amount of noise. Hence, omitting feature of the first and segments from subsequent comparison for identification or authentication may yield more accurate result.

FIG. 4C is a flowchart illustrating a process of comparing extracted features of acoustic signals, according to one embodiment. First, the similarity of features in each signal block of the acoustic signal obtained in the registration process and features of corresponding block obtained in the identification process is calculated 468. In one embodiment, a similarity score can be calculated for each block of the acoustic signal.

After determining the similarity of different signal blocks in the acoustic signals in the registration and the identification process, a matching score is calculated 472 based on the similarity of each block. In one or more embodiments, the similarity scores of the each signal blocks may be added to obtain the matching score.

If the matching score exceeds a certain value, the acoustic signal generated in the identification process may be determined to be generated by the same user who signed the signature during the registration process. Conversely, if the matching score does not exceed the certain value, the acoustic signal may be determined to be generated by a user different from the user who signed the signature during the registration process.

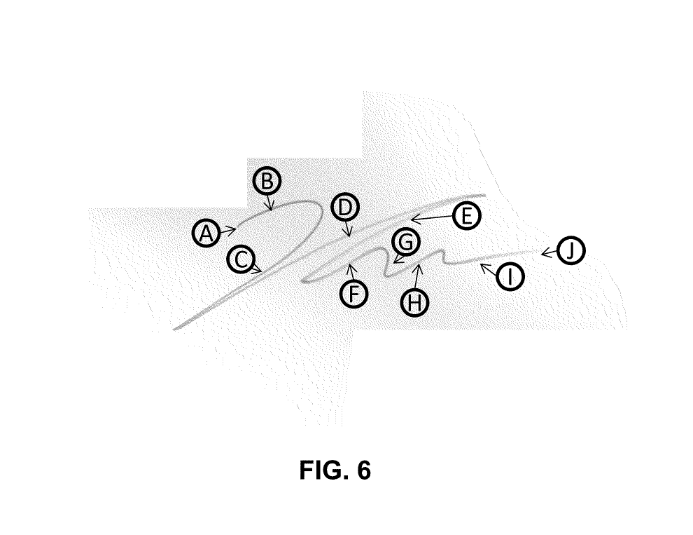

FIG. 6 is a diagram illustrating a signature image corresponding to the waveform of FIG. 5, according to one embodiment. In FIG. 5, parts of the signature associated with segments “A” through “J” are illustrated.

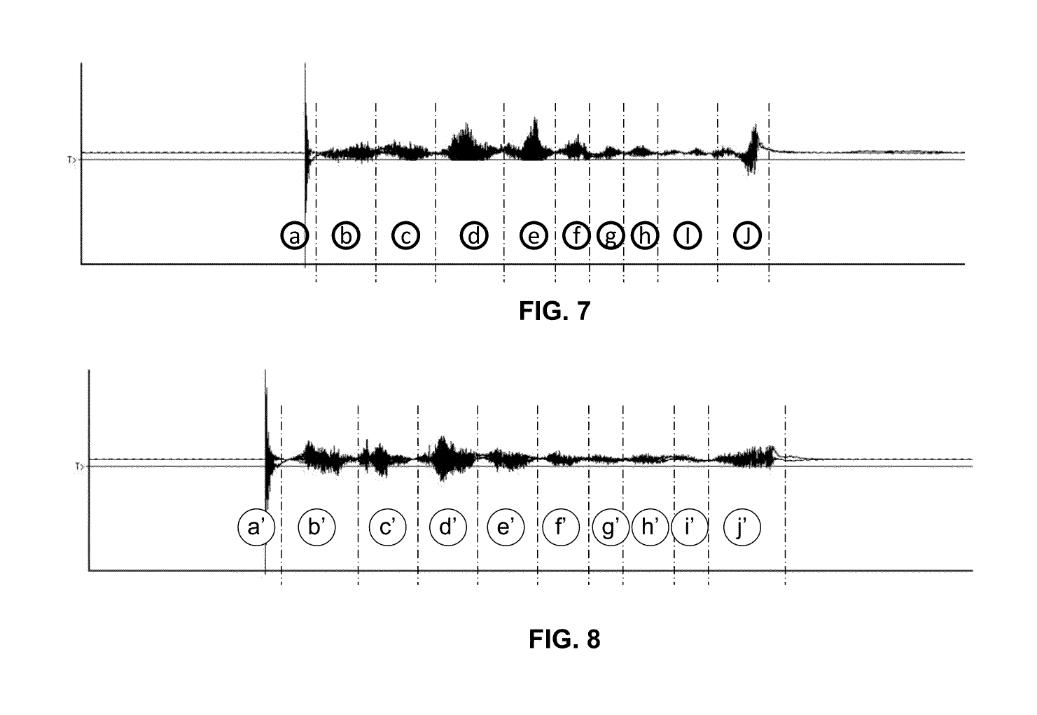

FIG. 7 is a graph illustrating another example waveform of an acoustic signal generated when the same signer of FIG. 5 signs on the touch screen at a different time, according to one embodiment. The waveform of FIG. 7 can be also be divided into 10 different segments “a” through “j” corresponding to segments “A” through “J” of FIG. 5. The waveform of FIG. 7 closely resembles the waveform of FIG. 5 in terms of comparative length of each segment, amplitude profile and/or frequency profile although the absolute amplitude of the peaks and the absolute lengths of each segment may be different.

FIG. 8 is a graph illustrating an example waveform of an acoustic signal generated when another signer attempts to mimics the signature of FIG. 5, according to one embodiment. The waveform of FIG. 8 can be also be divided into 10 different segments “a”' through “j”' corresponding to segments “A” through “J” of FIG. 5. The waveform of the sensor signal in FIG. 8 is different from the waveform of FIG. 5 in terms of comparative lengths of each segment, amplitude profile and/or frequency profile. Hence, by comparing features such as the speed of the pen or stylus for each segment (as derived from frequency profile of the waveform segments) of waveforms in FIGS. 5, 7 and 8, the signer or the signature can be verified or authenticated.

In one embodiment, the digital image of the signature as displayed on the touchscreen 228 and/or the digital image of the signature for storage may be processed to change line thickness at different parts of the signature according to the detected acoustic signal. Specifically, the acoustic signal may indicate the pressure exerted by the pen or stylus as well as the speed at which the pen or stylus is moving on the touchscreen 228. The signature as being written or being processed for storage may be displayed or processed to have a thicker line where the pressure of pen or stylus is high and the speed of the pen or stylus is low. Conversely, the line thickness in the portions of the signature where the pressure of pen or stylus is low and the speed of the pen or stylus is high may be displayed or processed to be thin. The same principle can be applied to applications such as drawings or photo editing tools executable on a digital device.

In one embodiment, the acoustic signal generated during the movement of the pen or stylus is used to determine the thickness or sparseness of line of the signature displayed to the user. For example, if the speed of the pen or stylus as determined by analyzing the acoustic signal at certain portions of the signature is slow, such portions of the signature may be displayed to have a thick line or densely populated dots. Conversely, if the speed of the pen or stylus as determined by analyzing the acoustic signal at certain portions is fast, such portions of the signature may be displayed to have a thin line or sparely populated dots.

Although the present invention has been described above with respect to several embodiments, various modifications can be made within the scope of the present invention. Accordingly, the disclosure of the present invention is intended to be illustrative, but not limiting.

1. A method for processing signature information, comprising:
at a sensor, detecting an acoustic signal generated at a first time during producing of a signature on an electronic device;
processing the acoustic signal to extract features of the acoustic signal; and
sending the extracted features as reference information for storage in association with the signature or a signer of the signature.

2. The method of claim 1, further comprising:
processing another acoustic signal detected at a second time to extract comparison features; and
comparing the comparison features and the stored reference information to authenticate the signature or the signer.

3. The method of claim 2, wherein the processing of the acoustic signal and the processing of the other acoustic signal is performed on a different electronic device.

4. The method of claim 1, wherein the signature is produced on a touchscreen of the electronic device.

5. The method of claim 4, wherein the sensor is embedded on the touchscreen.

6. The method of claim 4, wherein the touchscreen comprises a top surface with a grated or patterned to enhance the acoustic signal.

7. The method of claim 1, wherein the processing of the acoustic signal comprises:
amplification of the acoustic signal;
lowpass filtering of the amplified acoustic signal;
determining segment points based on the lowpass filtered acoustic signal; and
segmenting the amplified acoustic signal at points corresponding to the segment points of the lowpass filtered acoustic signal to obtain a plurality of signal blocks.

8. The method of claim 7, further comprising extracting features of the plurality of signal blocks as the reference information.

9. The method of claim 1, further comprising displaying the signature on the electronic device as the signature is being produced on the electronic device, wherein different portions of the signature are displayed to have different characteristics responsive to detecting difference in the extracted features corresponding to the different portions.

10. An electronic device comprising:
a surface configured to receive touch and motion representing a signature;
a sensor attached to the surface and configured to detect an acoustic signal generated at first time during which the touch and motion is being received on the surface; and
a processing module operably coupled to the sensor to receive the acoustic signal from the sensor, the processing module configured to extract features of the acoustic signal for storage as reference information.

11. The electronic device of claim 10, wherein the processing module is further configured to send the extracted features to a remote device via a network for storage.

12. The electronic device of claim 10, wherein the processing module is configured to process the acoustic signal by amplifying, filtering and segmenting.

13. The electronic device of claim 10, wherein the processing is further configured to:
process another acoustic signal generated from another acoustic signal detected at a second time to extract comparison features; and
compare the comparison features and the stored reference information authenticate the signature or a signer of the signature.

14. The electronic device of claim 10, wherein the surface is grated or patterned for enhanced acoustic signal.

15. The electronic device of claim 10, wherein the processing module is configured to:
amplify the acoustic signal;
lowpass filter the amplified acoustic signal;
determine segment points based on the lowpass filtered acoustic signal;
segment the amplified acoustic signal at points corresponding to the segment points of the lowpass filtered acoustic signal to obtain a plurality of signal blocks.

16. The electronic device of claim 10, wherein the reference information is used for comparison with comparison features extracted from another acoustic signal detected while receiving touch and motion on another electronic device.

17. The electronic device of claim 10, further comprising a display screen configured to display the signature responsive to receive touch and motion representing a signature, wherein different portions of the signature are displayed to have different characteristics responsive to detecting difference in the extracted features corresponding to the different portions of the signature.

18. An electronic device comprising:
a device interface configured to receive reference information generated at a first time based on reference features extracted from an acoustic signal captured during producing of a signature on another electronic device by a first user;
a surface configured to receive touch and motion representing a signature by a second user;
a sensor attached to the surface and configured to detect an acoustic signal generated at a second time subsequent to the first time during which the touch and motion by the second user is being received on the surface; and
a processing module operably coupled to the sensor to receive the acoustic signal from the sensor, the processing module configured to extract comparison features of the acoustic signal for comparison with the reference information.

19. The electronic device of claim 18, wherein the processing module is further configured to:
determine that the first user and the second user are identical responsive to matching of the reference features and the comparison features; and
determine that the first user and the second user are not identical responsive to the reference features and the comparison features not matching.

20. A non-transitory computer readable storage medium storing instructions thereon, the instructions when executed by a processor causing the processor to:
detect an acoustic signal generated at a first time during producing of a signature on an electronic device;
process the acoustic signal to extract features of the acoustic signal; and
send the extracted features as reference information for storage in association with the signature or a signer of the signature.
